(19) United States
(12) Patent Application Publication
(10) Pub. No.: US 2013/0054607 A1
(43) Pub. Date: Feb. 28, 2013

(54) Method and System for Preparing Digital Information for Long-Term Preservation

(71) Applicant: Henry Gladney, (US)

(72) Inventor: Henry Gladney, (US)

(21) Appl. No.: 13/219,630

(22) Filed: Aug. 27, 2011

(51) Int. Cl. G06F 17/30

(52) U.S. Cl. 707/741; 707/E17.002

(57) ABSTRACT

A system and method are provided for creating or extending a preservation-ready digital document. This document is represented so as to be durably intelligible and reliably trustworthy. It includes within itself standardized metadata, provenance information, and reliable links to chosen documents within a world-wide network of digital repositories. These links and the documents' own identifier(s) are chosen to uniquely, unambiguously, and forever identify what they refer to. This system provides a robustly durable method of preserving an unbounded number of digital objects for as long as their representing bit-strings are kept in existence and findable by now-conventional digital library technology, as first described in [Gladney 2000] and publications by the same author. The overall system herein described provides this service without requiring that pre-existing software be modified, and without requiring that any information object that it is intended to protect be modified from what its declared authors, editors, and producers created and provided as input for this preservation packaging service.

### BACKGROUND OF THE INVENTION

In the context of the current work, what we mean by “digital preservation”, “long-term digital preservation”, “LTDP”, “LDP” or variants of these names is the need of and methods for ensuring that a set of digital objects will be reliably useful in the future—any time from a few years hence until times so remote that no reliable authority about creation of the information under discussion is alive.

Related needs and capabilities are variously called “digital archiving”, “digital content management”, “content management”, “digital library services”, or variants of these names. In the context of the current invention, and of publications by its author, this collection of phrases should be read as having identical meaning. What we mean by a digital content management service is the digital analog of century-old services offered by libraries holding documents on paper, and perhaps also related artifacts, for the benefit of defined groups of clients—both clients who deposit works for safekeeping and also clients who either inspect such holdings on institutional premises (as is provided by the British Library) or borrow them for limited periods (as do the faculty and student clients of University of California libraries).

“Digital curation” is a recent name for a broad topic that includes archiving and LDP, and also the complex of activities, tools, and human procedures used to create, manage, and exploit digital holdings. E.g., digital curation includes construction and editing of metadata that describe the provenance and correct usage of digital holdings that are the primary information objects within all the domains alluded to.

Common language and thinking conflate and/or confound LDP with digital archiving. Such flawed thinking can be inferred from the tables of contents and articles submitted to the roughly half-dozen annual professional conferences discussing these topics. In contrast, the current invention is part of methodology that exploits manifest benefits of treating LDP and archiving as distinct topics that overlap, that can be coupled to please clients, and that can be combined to provide services that transcend what is possible with either alone.

1. Field of the Invention

This invention pertains to the care of digital information of lasting value, whether such information is primarily of academic, cultural, and intellectual interest, or consists of the working documents of governments, professional societies, NGAs, legal repositories, financial records, or other business enterprises large and small. It teaches a method of packaging digital objects so that the information collected in any such package will be perpetually reliable—both surely intelligible and reliably authentic.

2. Description of the Related Art

Among potentially interested parties, only academics and members of related professions communicate their pertinent needs, opinions, and proposed practical measures in published articles and professional conferences. If private enterprises—either prospective service providers or prospective customers—are thinking about these topics, they are also managing their insights as trade secrets. I.e., a reliably complete assessment of the related art is not at this time feasible.

The scholars who share their insights and opinions publicly mostly agree that the solution for long-term digital preservation will be conformance to a set of “best practices” within archival institutions. They have described their ideas in scores of articles and conference proceedings. The methods that this literature describes would be expensive to implement comprehensively, perhaps even beyond the resources of the organizations that employ these authors. Even worse, it would be prone to deficiencies and flaws that make reliance on the authenticity of the digital works cared for imprudent, especially for legal, financial, and health-care documents.

Bits and pieces of technology that are combined in the current invention do exist, but have neither been applied to LDP nor combined in ways that are essential for reliable and practical tools serving end users' needs. Nor does the publicly available literature reveal any competitively practical method for providing LDP; neither similar nor radically different methodology has been proposed that would be effective.

### SUMMARY OF THE INVENTION

The current invention disclosure describes how to create a “preserved information package”—a PIP. Its objects and advantages are consequences of certain desirable PIP properties. To facilitate the descriptions and clarify them beyond what would otherwise be the case, these are made for a particular PIP design that we call a TDO—a Trustworthy Digital Object. Other PIP designs would be variants of TDO design that will be obvious to software engineers, as will be how our ensuing design for a TDO editor can be altered to prepare digital objects that conform to some alternative PIP design.

The current invention describes a practical and economical procedure and method for constructing such a reliable TDO—a method whose use can easily be taught to ordinary citizens and is nevertheless attractive to archivists and other information professionals. By example, it also describes procedures and methods for preparing a reliable PIP whose structure might be different than that of a TDO.

Each TDO is reliably interpretable and verifiably authentic whether or not any authority for its content is available to answer questions and/or testify about the information conveyed within this package. A correctly constructed TDO comes as close as is feasible to meeting certain well-defined digital object properties for information reliability today and also in the distant future.

For circumstances in which the theoretical desirable properties cannot be achieved because parts of TDO technology are not yet available, the current invention also describes how to construct less reliable digital objects that approximate the ideal information representation as closely as possible at the time they are constructed, doing so in a way that makes the shortfalls from perfection easy to understand.

The invention describes a tool that achieves all this in ways that will appear to its users to be a compatible extension of document creation and editing tools with which these users are already familiar—tools that children now learn to use in elementary school.

Desirable Properties of a Preserved Information Package (PIP)

The disclosed TDO editor obtains its advantages over potential alternatives by being an easily used tool by anybody who frequently uses word processing or picture editing software and from the uniquely useful properties of the data objects it helps prepare—properties consequent on their conforming to TDO architecture.

No directly competitive technology exists today for creating PIPs and exploiting their useful properties. Furthermore, both TDO architecture and also TDO editor design are so simple that we believe any PIP competitors that might in the future be devised will be either obvious variants or more complex in their usage, structure, and inner workings. To understand the workings of this invention and to judge their correctness, it helps to understand TDO properties that provide reliable long-term digital preservation. We ask and answer a key question.

Many Years From Now, What Might Someone Want of Information Stored Today?

This person might be a scholar who wants to interpret and extend our writings, a physician consulting your medical charts of 40 years earlier, or an attorney surveying fiduciary records. For some applications, information consumers will want and demand evidence that information they depend on is authentic—that it truly is what it purports to be. For every intended application, they will be disappointed by lost information that they learn once existed. For every application, they will be disappointed by received information that they cannot read or otherwise use as they believe was originally intended. Each FIG. 1 individual information consumer might want to use the content of an “interesting” TDO in all the ways its long-dead information producer(s) intended when they packaged this TDO.

For this, preservation methodology must address the challenges of finding, demonstrating, and testing for:
1. Ensuring that a copy of every preserved document survives as long as it might interest someone;
2. Ensuring that authorized consumers can find and use any preserved document as its producers intended, avoiding errors introduced by third parties that include archivists, editors, and programmers;
3. Ensuring that any consumer has ready access to means for deciding whether information received is sufficiently trustworthy for his intended application;
4. Hiding information technology complexity from end users (producers, archivists, and consumers);
5. Replacing human effort by automatic procedures whenever doing so is feasible;
6. Empowering authors, editors, and other information producers to package information so as to relieve overloading of professional cataloguers;
7. Enabling gradual migration of huge numbers of current digital holdings to preservation-worthy representations and packaging; and
8. Enabling effortless interchange of packaged information among institutions and individuals.

Each TDO provides essential parts of #2, #3, #4, #5, #6, #7, and #8.

An implementation of our invention will work compatibly with other parts of a complete preservation solution; several such parts are known and widely deployed today. Other parts are still being addressed by other workers, and will not be described in the current disclosure.

Viable complete solutions will allow digital repository institutions and also individual users to continue to exploit digital document technology they have already deployed and its evolving replacements without disruption, conforming to software interface standards and conventions that permit “mix and match” from competing providers—standards and conventions that, over time, will be improved over today's versions. These tools include:
9. Digital content servers that store TDOs, and that provide search and access services;
10. Replication mechanisms that protect against the loss of the last remaining copy of any digital object;
11. Topic-specific ontologies defined, standardized, and maintained by professional communities;
12. Additional metadata schemes and elements, particularly for previously unsupported kinds of information and file schemes these employ; and
13. Socially-communicated languages and standards for encoding starting points.

Summary of Method for Creating and Improving a Preserved Information Package

Each TDO conforms to the data schema suggested by FIG. 2, FIG. 3, and FIG. 4. What makes this so is a TDO editing program that is the subject of the current disclosure.

To prepare an object set that makes up a work, an author or publisher causes conversion of each content bit-string he wishes to preserve into a durably intelligible representation and collects the results, together with standardized metadata, to become the payload of a new TDO. In addition to its payload, each TDO has a protection block into which a human editor loads metadata conforming to evolving standards and records relationships among parts of the new TDO and between it and other objects. The final construction step, executed at a human agent's command, is to seal this bundle with a cryptographic signature block.

The TDO editor implementation includes code to ensure that what it is being used to create or amend satisfies requirements for being a TDO. Specifically, in a perfect TDO:
The bit-string set that represents the version is XML-packaged with registered schema.
These bit-strings and metadata are encoded to be platform-independent and durably intelligible.
The metadata include identifiers for the new object and for prior versions of the work represented.
Every critical link to other information is secured by a message authentication code.
The package includes or links reliably to all metadata needed for interpretation and as evidence.
All these contents are packaged as a single bit-string that is sealed using cryptographic certificates based on public key message authentication.
Each cryptographic certificate is authenticated by a recursive certificate chain rooted in a trustworthy institution.

At the time creating a TDO is wanted, it might be impossible to create a perfect TDO for an information collection of interest. For instance, the blob rendering method described in U.S. Pat. No. 6,044,378 [Lorie 2004] might not yet have been reduced to practice for blobs of all the types in this collection; or else the metadata schema for these data types might not yet have been fixed in international standards, and therefore might later change. Such circumstances are likely in the near future, growing less likely as the world's software infrastructure is extended and refined.

For any such case, TDO packaging will still be useful, because it includes a feature suggested by FIG. 4—recursive embedding of TDOs within one another. As the missing software technology becomes available, a digital curator can use the TDO editor described to create a new TDO that exploits the new technology, embeds the old TDO within this new TDO, and records these actions in the new FIG. 3 protection block.

### OBJECTS AND ADVANTAGES

The useful services afforded by this invention have been described as list items 2, 3, 4, 5, and 6 in the Desirable Properties of a Preserved Information Package (PIP) section above.

Any PIP is also an Archival Information Package as described within the forthcoming ISO OAIS standard.

Further objects and advantages of this invention will become apparent from a consideration of the drawings and the ensuing description.

### BRIEF DESCRIPTION OF THE DRAWINGS

The above objectives and advantages of the present invention are made more apparent by describing in detail preferred embodiments thereof with reference to the attached drawings. In these:

FIG. 1 sketches how information might flow from any information producer to an information consumer, simplifying real world behavior by not showing many alternative paths.

FIG. 2 suggests TDO schema by depicting a relatively simple TDO example.

FIG. 3 elaborates the FIG. 2 protection block by sketching metadata that an instance might contain, doing so without pretending to illustrate all possible inclusions.

FIG. 4 illustrates that TDO structure is recursive—that any FIG. 2 content block might itself be a TDO.

FIG. 5 depicts some of the features of FIG. 2 and FIG. 3 in a different fashion.

FIG. 6 depicts a sample directory that is part of a Microsoft Windows disk directory. Every computer operating system offers similar functionality that can be exploited as is described below.

FIG. 7 depicts control flow of the core of a TDO editor—the portion that enables editing, addition, or deletion of some content or metadata blob.

FIG. 8 depicts control flow of a second core portion of a TDO editor—the portion that enables editing, addition, or deletion of some link within a TDO or connecting to another TDO

### DETAILED DESCRIPTION OF THE INVENTION

This invention describes rich and yet easily understood methods of wrapping information of long-term value to create a TDO that will ensure that certain specific qualities are durably preserved over time to the extent theoretically feasible.

Specifically, the invention is a TDO editor that enables information producers to prepare and wrap information for durable reliability and legibility, doing so with almost no specialized training, and that enables human information consumers to extract such information for reading and other applications, and also to evaluate its authenticity by inspecting its provenance and testing that nothing has been altered since a TDO of interest was created.

To make the following invention description as simple as possible, before detailing its specifics the following sections describe social use and structure of TDOs.

TDO Structure Details Referred to in the Detailed Process Description

Human Roles and Relationships in Communicating Information

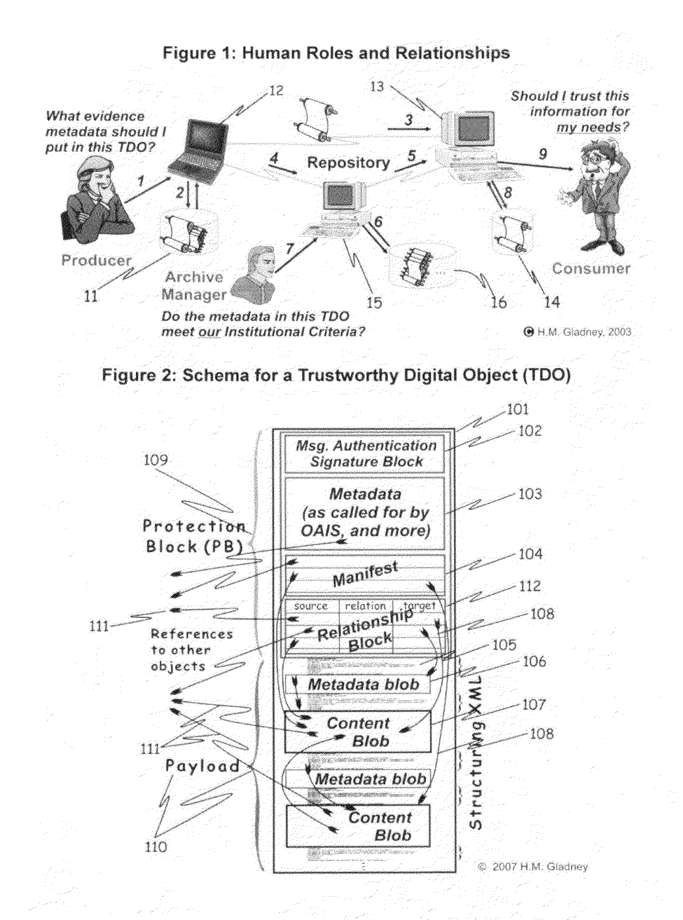

FIG. 1 suggests three human roles, pathways by which information might flow among such human beings, and typical questions that they might ask in connection with their depicted roles. An Information Producer is a participant in preparing information for later sharing with one or more Information Consumers. An Archive Manager (a.k.a. Librarian) is someone whose responsibilities include managing some portion of digital document curation.

These human-being depictions indicate social roles rather than individual relationships with digital repositories. For instance, many employees of the U.S. National Archives and Records Administration (NARA) act as Archive Managers at least occasionally, as does a clerk of a law court. Well-known examples of Producers include authors, editors, and publishers. Consumers include library patrons, viewers of video productions, recipients of legal briefs, and so on. Any NARA employee almost surely sometimes acts as an information consumer, and perhaps also sometimes as an information producer.

Other names are conventionally used for such roles, with different names being in different professional and social communities and for different kinds of information (e.g., the author of a legal brief is likely to be referred to as an attorney). Within the context of the current invention, distinctions that such different names signal are irrelevant. I.e., roles and actions pertinent to digital preservation do not depend on such differences; the method described can be usefully applied to every known instance of preparing, caring for, or using any kind of preserved information.

Each participant in digital preservation typically has questions, or answers to such questions, about his/her responsibilities. These questions and their putative answers are extensively discussed in professional periodicals, such as D-Lib Magazine (http://www.dlib.org/) and also the Journal of Digital Curation (http://www.ijdc.net/), and therefore are not discussed further in the current disclosure.

Each user interacts with the rest of the world through a computer (12, 13, and 15 in the figure). Typically, but not necessarily, these are personal computers, each with local persistent storage (11, 14, and 16 in the figure). These human beings and machines interact through means 1, 2, 3, 4, 5, 6, 7, 8, and 9. Such interaction paths might be Internet links or other kinds of computing and communications hardware. These connections are unidirectional, with information of interest moving from a Producer towards a Consumer in asynchronous steps that might occur after long delays—perhaps only after many years.

Each figure element 1 through 16 suggests only a single instance from a multiplicity of similar instances. More than one instance of each numbered entity might be made available and might also in fact be used to ensure that some pathway is available between a Producer and a Consumer in order to overcome unreliability that might cause preferred pathway(s) to be unavailable. Thus, a preserved object is likely to be stored in many repository (15) storage subsystems (16). For instance, dozens of academic libraries hold copies of D-Lib Magazine numbers.

Schema for a Trustworthy Digital Object (TDO)

FIG. 2 suggests structure and content of a Trustworthy Digital Object (TDO), and also one kind of depiction for showing a TDO instance on a display screen. Such an image can help a human being interact with portions of a TDO to inspect and/or change their content, changing component membership of some TDO, changing link(s) that record how these components are related or change link(s) that record how information in some TDO is related to that in other data objects, or to real-world physical objects.

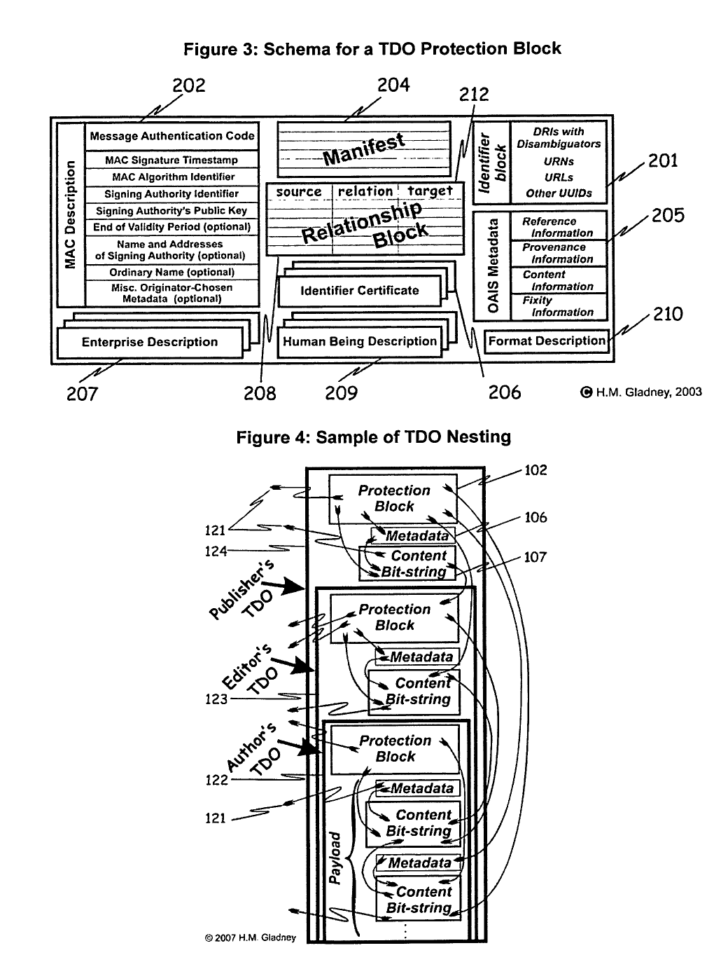

Each TDO has a single Protection Block (109), depicted with more detail in FIG. 3, and a Payload (110). The Payload consists of any number of Content Blobs (107). Each such Content Blob might be accompanied by a Metadata blob (106), which might be structured similarly to a Protection Block or might have structure and content chosen by a Producer for his own purposes.

A TDO without any payload can be useful to describe pending payload, or to relate information in other digital objects, or to describe information that might never be contained in digital objects.

Apart from a protection block, any depicted block might be missing or empty. A protection block might be empty except for identifiers in its metadata (103) and a Message Authentication Signature Block (102).

In this disclosure, the word “bit-string” is a precise synonym for “blob”.

TDO components are knit together with text in “glue language”. Today's preferred glue language is XML (105, labeled as “Structuring XML” in the figure), but other choices are possible. In fact, XML itself might be replaced by another language in years to come. FIG. 2 includes many arrows (108 and 111). Each such arrow indicates a link (such as a program pointer, bibliographic citation, or WWW link) which can occur within any block. Link data are names or identifiers of data objects either within the current TDO or externally. Alternatively, any link might indicate a physical object, such as a particular automobile, or a location in the real world (such as London's Trafalgar Square). In conventional usage, these names/identifiers are referred to in many ways, e.g., as “bookmarks” in Microsoft Office Word, as ISBN numbers of published books, and as storage locations within digital computers. Alternatively, link content might be ambiguous literal descriptors.

Typically, identifiers are resolved into specific locations or objects in libraries and in computers by catalogs and/or databases. The most useful identifiers are each unambiguous within their domains, with these domain recognizable by whatever processes are used to follow such links. There exist many well-known schemes for such identifiers. There also exist methods known by experts for creation of new schemes of such names and identifiers. Therefore this disclosure does not elaborate on identifier creation or use.

To be useful, it is not necessary that an identifier refer to an existing object or location. That connection can be provided long after an identifier is first used.

An Information Provider who is not the original author of a Content Blob might want to add new bookmarks to that blob without making any change within it, because such a change would destroy the blob's authenticity. TDO structure provides for this need by means of its Relationship Block (112), which is a component of the Protection Block (109). This block is a table (representing a mathematical relation) of unlimited length with three or more columns. Its source and target columns each contain locators designating places within other objects. One locator form (among many possibilities, any number of which might be employed by TDOs described) is a combination of an identifier of a blob within the current TDO (108) or within an external object (111) followed by an offset, counted in bits, digital words, or any other convenient counting scheme, that indicates how far a place of interest is from the beginning of its containing blob.

Each included Metadata blob (106) is likely to contain descriptive and administrative information helpful to an eventual Information Consumer. This content might depend on the type of data being described (e.g., different for a JPG image than for a PDF document); parts might be Information Producers' ad hoc choices. The content and format of such metadata is under investigation by independent teams for some of the hundreds of data formats currently used. The current invention does not depend on these choices; as quickly as new metadata formats are chosen and standardized, described data types and metadata might be used to improve already existing TDOs as well as in new TDOs. How to accomplish this is described and claimed as part of the current invention.

A TDO might contain and communicate no content blobs. Such a TDO would be a means of providing durably useful descriptors of physical objects, perhaps mimicking ways in which 3″×5″ catalog cards described library or museum holdings 70 years ago.

Schema for a TDO Protection Block

FIG. 3 provides detail for a TDO Protection Block beyond what was convenient in FIG. 2.

A TDO Protection Block (PB) is a schema and a content block that collects various kinds of metadata, and is extensible to embrace metadata kinds not mentioned below. Most depicted sub-blocks (201 through 209) are optional. I.e., a PB might be almost empty.

A proper TDO will contain a PB, so that any Consumer can be confident that lack of usual metadata is deliberate rather than an oversight. However, an empty PB is likely to indicate a Producer's error, because digital libraries and other repositories cannot make their holdings available without identifiers.

The Identifier block (201) contains at least one globally unique identifier (conventionally called a UUID—Uniform Unique Identifier—and so referred to below), and might contain any number of additional identifiers to accommodate specialized identifier format protocols that conform to well-known conventions (such as book ISBNs) and standards. Any such additional identifier might be either global in scope or else unique within a domain that is conventionally understood for objects of a kind being described.

The MAC Description (202) holds digital signature information required for cryptographic authenticity protection. Such cryptographic protection is well known, having evolved since it was introduced in the 1980s, with many available practical tools, all conforming to numerous national standards, international standards and widely used conventions. (For instance, XML packaging for signing with a time stamp is standardized in W3C's XML Advanced Electronic Signatures, http://www.w3.org/TR/XAdES/. See also XML-Signature Syntax and Processing, http://www.w3.org/TR/xmldsig-core/.)

The Manifest (204) is a table identifying every content blob (107) and metadata blob (106) within a TDO payload, together with information needed to locate this blob. Optionally, it might contain further fields for descriptors of content elements. Its representing table can have any number of descriptor columns.

The OAIS Metadata block (205) conforms to yet another widely-known convention—one that is within a year of being endorsed within an ISO OAIS standard. As such, it neither needs nor is afforded further description within the current disclosure.

The Relationship Block (208) has already been incompletely described in connection with many FIG. 2 links. It remains only to describe its relation elements. Each relation element describes the intent of the connections made by corresponding source and target links. Its value could be a character string or a link to an arbitrarily complex description.

Remaining blocks, Enterprise Description (207), Human Being Description (209), Identifier Certificate (206), and Format Description (210), are descriptors whose names suggest their purposes. Further kinds of information descriptors might at future dates be added to the protection block schema without disturbing anything in this invention.

Sample of TDO Nesting

FIG. 4 suggests a key feature of TDO structure—that it is recursive. Any Content Bit-string (197) might itself be the kind of TDO illustrated in FIG. 2. The figure suggests a structure that might arise from one plausible scenario—one that implements the following users' behaviors.

Some book author creates his masterwork and, wanting to preserve this so that his eventual biographers would know his words precisely, creates an Author's TDO (122), sending this object to a copy editor.

This human copy editor, seeing opportunities to improve an author's work, does so and combines his modified paragraphs into a new TDO (123) that contains the author's TDO. This he can do with a TDO editor simply by selecting some content block of the author's TDO, opening and editing it. Our TDO editor automatically creates a new content block within the outer TDO that is a copy of the selected author's content block and makes that available for editing, linking it to the corresponding content block in the author's TDO. Thus the human editor can record changes without in the smallest measure disturbing the author's original (122). Finally, he commands the TDO wrapping program to package his extensions, together with the author's submission, into a new TDO, calls on the TDO editor to seal that cryptographically, and sends this new TDO to a publisher.

The publisher cannot send for printing what he receives from the copy editor without further improvement. He almost surely must reformat the work to conform to page size constraints and other niceties of producing an attractive object that will appeal to customers. He will surely need to add things such as the front matter pages that libraries require; for instance, he must add a page containing a book's ISBN identification. Having done all this, like the human copy editor, this publisher might want to retain the full, detailed history of creation, starting with the author's version. This he can conveniently do by combining all the prior material into a TDO (124) that he sends to the printer, and also to a few archives that promise best efforts towards keeping this final digital version for posterity.

Alternatively, each participant might have prepared a new TDO that merely identified the earlier versions by linking them as external objects (121). The TDO mechanism for managing correctness and authenticity of links would make doing it this way almost as durably reliable as perpetuation by nesting. However, nested versions are marginally more reliable and less expensive to save forever.

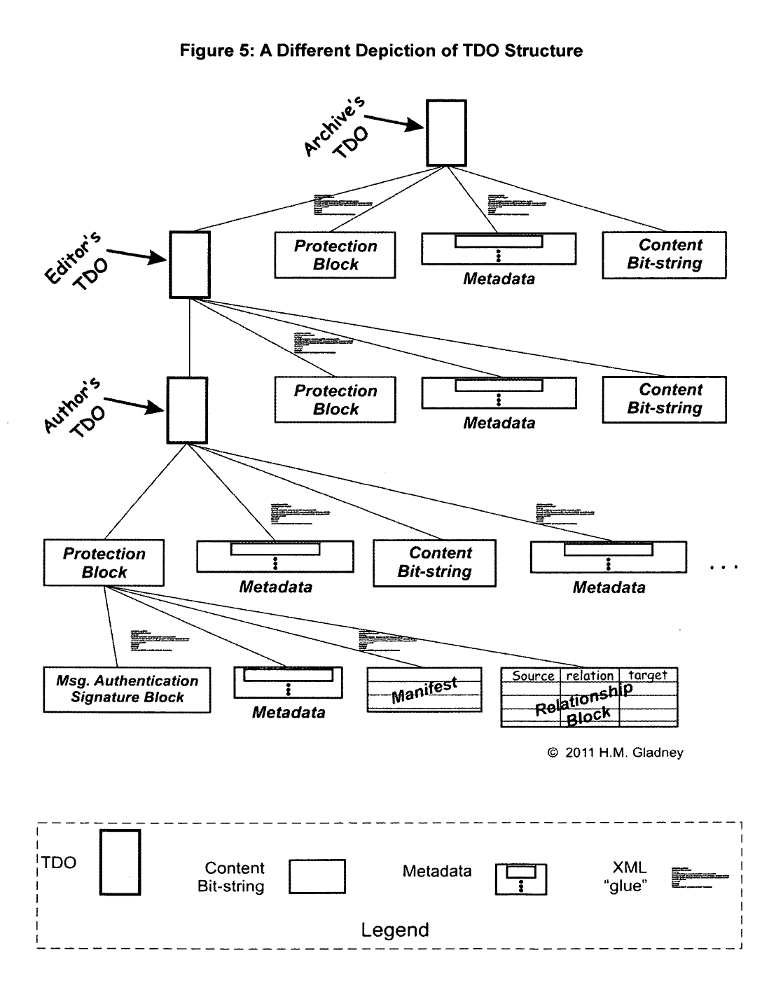

FIG. 5 is an alternative depiction of what FIG. 2 and FIG. 4 depict. Specifically, it suggests structure and content of a Trustworthy Digital Object (TDO) without indicating links. It is another kind of depiction that might be used on an interactive display screen to show a TDO instance on a computer screen to an information producer or consumer in order to help these human beings interact with portions of a TDO to inspect and/or change its content. Any block in such a diagram allows its components, connected blocks below it, to be shown or hidden. Additionally, the kinds of link information that embellish FIG. 2 and FIG. 4 might be shown for any subset of blocks. (That is not depicted here because doing so would conceal the simplicity of what FIG. 5 does show.)

Detailed Process Description of the Invention

This invention is an editing program and a wrapping tool for collecting data objects, recording their relationships to one another, and finally securing evidence of this work's provenance within a single data object that satisfies certain properties needed for long-term reliability. Specifically, this TDO editor is intended to help an information producer create a new TDO or upgrade an existing TDO, doing so with a minimum of specialized training. It accomplishes this partly by ensuring that changes conform to required TDO content and format rules, and by prompting its user with hints for choosing alternatives when such are available.

The TDO editor can also help any eventual information consumer inspect payload elements of any TDO, or otherwise use these contents as its information producer(s) intended, providing means whereby any consumer can inspect a TDOs provenance and structure information and test that nothing within a TDO has been altered since it was created.

Essential properties and treatment of a TDO, and theoretical reasons why each is important, have been described in [Gladney 2006] and [Gladney 2007]. Briefly, they include available means for storing and finding a copy of a TDO together with important descriptors that include provenance information, means for making content intelligible many years later than it was created, and means whereby any eventual information consumer can test whether it is reliably authentic.

As is done for many other editors, a TDO editor is delivered to its users in the form of an editor program proper, a parameter file that is partly complete and partly to be completed by a user, various auxiliary files, and an installation program. The parameter file's completed values include, for each currently supported information content file type, identification of the current best preservation format together with identification of program(s) available for converting files encoded with earlier formats to this preservation format. Typically the latter programs are provided by companies/organizations that market and support editors for file types of interest. For instance, today Microsoft's Office Word program has ability to ingest older MS Word formats and producing MS Word 2007 format files that contain all the information conveyed by older versions. The installation program helps its user by connecting the program proper with a parameter file and prompting the user to supply his choices of values suitable for local circumstances.

As with other editors, the TDO editor and parameter file will, from time to time, be made available in updated form. This updated form will, for instance, identify a latest list of supported content file types and a then-current best preservation format for each supported file type.

Each executing instance of a TDO editor opens or creates and manipulates an ephemeral storage representation of a TDO, similarly to how any other editor creates and manipulates instances of its special data types (e.g., OpenOffice text files by the OpenOffice Writer program, JPG files by JASC PaintShop Pro, and so on). Whenever its user chooses, it stores a copy of this onto a hard disk drive (HDD) or other persistent storage at a user-chosen location and under a user-chosen name. I.e., a TDO editor operates similarly to many other editor programs, differing only in those aspects that differentiate a TDO from another kind of data object.

Extending an Existing TDO

Suppose that a user has reached a plateau in creating a TDO and wants to extend this draft TDO by adding an additional content blob (107 in FIG. 2). At that point, ephemeral storage of his computer will contain a representation of current state of this TDO and persistent storage of his computer will contain copies of each of this TDO's content elements organized in a conventional directory. We refer below to this chosen directory as a “focal directory”.

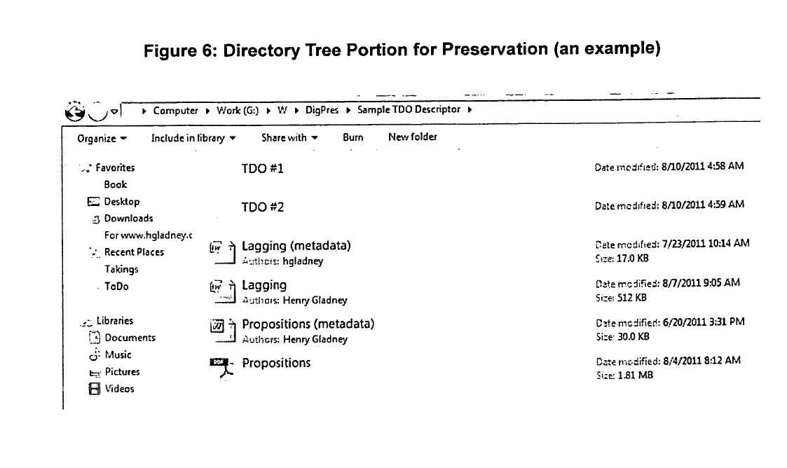

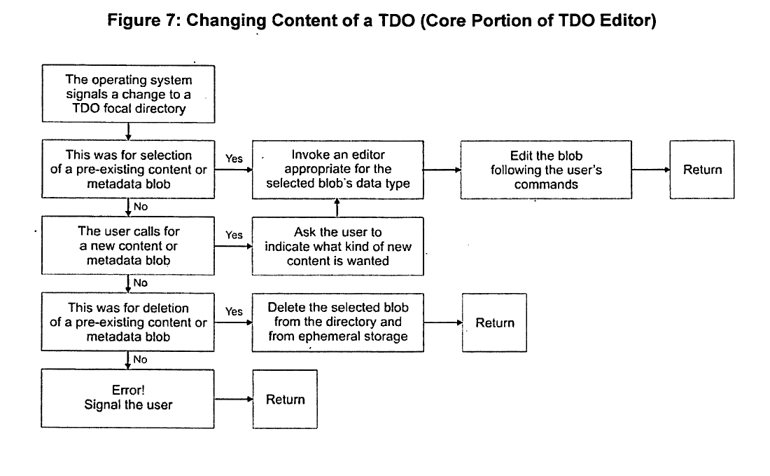

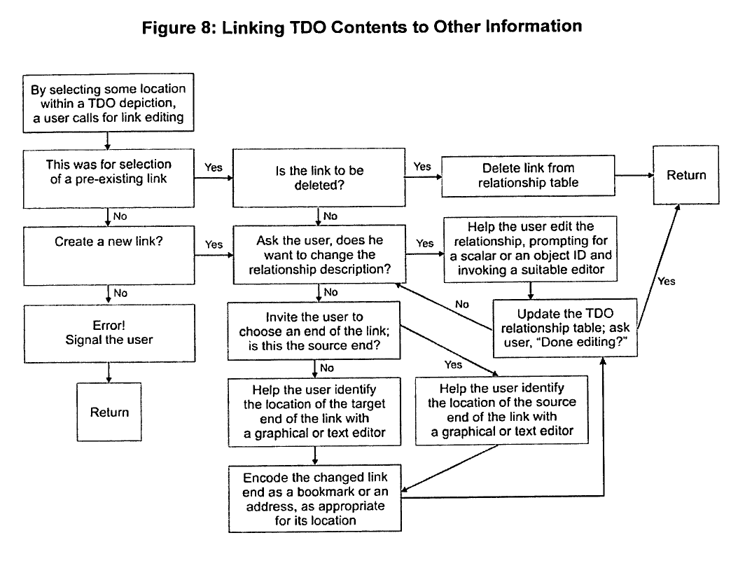

This persistent storage collection will be accompanied by an interactive directory display of a focal directory (FIG. 6). This kind of directory display and implied well-known services are provided by any personal computer operating system; any such can be used by a TDO editor, i.e., FIG. 6 is merely an example. A user can interact with a focal directory in all the usual ways supported by a computer operating system. For instance, if he asks that the illustrated “Lagging.doc” file be opened for inspection and alteration, his request will invoke a Microsoft Word editing session instance.

A focal directory, “Computer/Work(G:)/W/DigPres/Sample TDO Descriptor” in the example, might contain (refer to) any number of any kind of computer files (e.g., “Lagging.doc” in the example) and any number of subdirectories (e.g., “TDO #1” in the example) that themselves may have their own subdirectories. Any of these objects might be marked as read-only either before a TDO editor connects to a focal directory, or later marked as read-only. Any read-only object may at any time have its read-only marking removed.

Content of a focal directory might be, at any time during a TDO editor execution be changed by removing objects. If a user chooses to remove any focal directory entry, a TDO editor will mirror this change by removing corresponding content from its ephemeral storage representation of a draft TDO, together with all other content that depends on existence of now-missing content.

To begin adding new content to a TDO, a user can copy an existing file into a focal directory, optionally accompanying this by copying a previously prepared metadata file appropriate to a content file. In the context of a file system, content-to-metadata relationships are signaled syntactically. For instance, this might be done through a convention in which a metadata file “NewFile (metadata).doc” is associated with the primary content file “NewFile.doc”.

If such an accompanying metadata file is identified, a TDO editor tests whether its type is appropriate for a related content file and whether all required metadata fields have been filled in as called for by a metadata specification appropriate for that type, if such a specification exists. If no accompanying metadata file is provided, a TDO editor searches its parameter file for identification of an appropriate type or prompts a user to identify a suitable metadata template. In either case, the TDO editor prompts the user with a fill-in-the blanks metadata editor suitable for a type of metadata required. At every stage of this process, a TDO editor allows a user to specify, “I don't want to do that now”, and saves as much of metadata as is then available. This process might end without metadata to accompany a new content object.

Whenever a user informs a metadata editor that he wishes to end its activity, an optional search for incomplete metadata is made available to continue the process of the prior paragraph. If he chooses not to complete this process, he will be permitted to save an imperfect TDO whenever, later in his editing session, he indicates a current TDO should be saved.

A TDO editor then updates an ephemeral storage representation of the TDO to correspond to a current focal directory display by augmenting it with a content blob representation and as much of a metadata blob representation as automatically generated and user provided inputs allow.

Whenever necessary as part of these and later actions, a TDO editor augments a TDO's ephemeral storage representation by including structuring XML (a.k.a. “glue”, as suggested by 105 in FIG. 2). This glue consists of a few XML lines preceding each included object (for every kind of block suggested by FIG. 2), and a few more such XML lines following each block. Most of this XML is invariant, but it includes a few fields for which a TDO editor chooses values that are unique within the TDO at hand. These include a local name for referring to a block at hand and a pair of nonces whereby a TDO editor can identify and navigate to the first bit or the last bit of this block.

Prior paragraphs of this subsection have mostly had to do with augmenting a current TDO with a new content blob. A TDO editor supports similar action for a new contained TDO. E.g., it might augment its focal directory by adding a new subordinate TDO, e.g., a new “TDO #3” in FIG. 6. To call for this, a user needs only to copy a directory from elsewhere into a new subdirectory of a focal directory, naming this new subdirectory however he chooses. A TDO editor will then proceed as indicated in the Updating a Prior TDO subsection below.

Whenever he wants to edit a subordinate TDO, such as “TDO #2” in FIG. 6, a user needs only to open a persistent storage copy by selecting its displayed directory entry, just as he might open any ordinary subdirectory. He might do this either within a current focal directory display window or into a new directory display window. If he chooses the latter, he will be able to edit any entry in either window; a TDO editor will simply fork a new editing task.

As the prior paragraphs illustrate, and as will be possible to infer from descriptions of other actions in later subsections of this Process Description of the Invention, any persistent storage content action that a current operating system supports via manipulations in its directory browsers can be used on a focal directory of an open TDO. What is different, and new in this invention, is that a TDO editor will mirror such conventional peripheral storage content changes in its ephemeral representation of a TDO.

Deleting Content of a TDO Being Edited

Whenever he chooses, a human user may delete any entry in a focal directory display, thereby deleting an object it identifies from persistent storage. Whenever an executing instance of a TDO editor completes work that might be in process or queued for processing, it will update an ephemeral storage representation of a TDO it is processing to reflect these deletions.

Creating a New TDO

When a user activates a TDO editor instance without pointing at a directory, he is prompted to define a new directory, placing this wherever he chooses. This causes a TDO editor to create a new TDO representation in ephemeral storage, to create as much of its Protection Block as can be automatically done, to prompt a user to choose a schema for a metadata block within a protection block, and to enter other information that cannot be automatically generated, accomplishing part of this by invoking a metadata editor appropriate for a just-chosen schema. A user could instead command a TDO editor to create an internal list of TDO portions requiring user information—a list for display whenever a user requests, and allows this user to select a TDO portion to attend to.

A metadata editor then helps a user to extend, edit, and delete a TDO's content and metadata as described in prior sections of this disclosure.

Saving an Incomplete TDO

If a user chooses to save an open TDO persistently, if portions are incomplete a TDO editor prompts him to choose to save this draft TDO for completion later. A TDO editor can later be invoked to act on such a draft TDO. If a user later chooses to do so, a TDO editor recreates an ephemeral storage representation and prepares itself to execute as if there had been no temporary activity suspension.

Editing Links Within a TDO, Between TDOs, and from TDOs to Other Objects

As suggested by FIG. 2 and FIG. 4, TDO architecture includes several kinds of links in addition to all kinds of bookmarks, references, and hyperlinks supported by OEM tools.

Each link is made up of a link source location, a link target location, and an optional indicator of the type of relationship conveyed by this link. A TDO editor makes available interactive means of changing any link component independently of the other two. If a relationship component is specified, such a link is represented by a row in the FIG. 3 Relationship Block. It is also so represented if either a source location or a target location is within read-only content or metadata. Otherwise a link source location is constructed by editing a source blob with its OEM editor in whatever way that editor calls for and supports, and a link target location is constructed similarly.

If a Relationship Block row is needed and used, a TDO editor prompts a user to indicate a link source location by pointing into a screen representation of a source blob. A TDO editor uses this choice to enter a location name or address into a source field of a Relationship block. The form of this name or address depends on its source location. For instance, if the source location is within a content blob of a TDO currently being edited, it might be a local identifier/name of this blob together with a byte offset within this blob, or a local identifier/name together with an available bookmark that a blob already has. If a source location is in an external TDO, such locations are augmented by a UUID for this external TDO. If a source location is within another kind of digital object, physical object, or geographical location, internal parts of the source location are augmented by a conventional name or locator for this kind of object. For instance, this might be a WWW link name, in the style “http://a.b.c.com/object.html”.

If a Relationship Block row is needed and used, a TDO editor prompts a user to indicate a link target location, and helps him handle it as has just been described for a link source location.

If a user has asked a relationship descriptor, a TDO editor prompts this user to provide a value. This value might be either a scalar value (probably, but not necessarily, a text string) or an identifier of an internal or external data object. For the latter, a TDO editor supports any kind of location indicators and editing that have just been indicated for the link source location.

The meaning and implied behavior of such relationship information has no significance to the TDO editor or effect on its actions. Instead, these are chosen by and for the benefit of application services outside the scope of this disclosure.

Closing a TDO Editor Instance and Saving Work Done

A final construction step, executed at a human agent's command, is to seal an edited TDO bundle with a cryptographic signature block. This is done with well-known cryptographic technology [Menezes 1997], using message authentication codes and asymmetric key encryption. Sealing a TDO starts with constructing a message authentication code for the entire TDO except for a yet-to-be completed MAC Description (202 in FIG. 3).

Before this is done for an entire TDO, the same technique is applied to the information representing each external link, with this information stored within a Protection Block. I.e., when an entire TDO is protected, this will include protection for sealing information for external links.

These measures will generate, and their efficacy will depend on, public key portions of asymmetric encryption keys. These public keys need to be protected so that their eventual users know that they are authentic and were created as part of TDO sealing by information creators identified within a TDO protection block. That keys are protected is essential for TDO reliability. Methodology for protecting these keys is not part of the claims of the current disclosure.

### A First Alternative Embodiment

In an alternative embodiment, a user is shown a screen image similar to one of the FIG. 2, FIG. 3, or FIG. 4 depictions, depending on which is appropriate for an action requested. A user may then select a point or an extent within such an image, doing so with conventional computer mouse, cursor, and/or keyboard actions. The effect of such a selection will depend on the precise location or extent selected. Possible effects would be that a TDO editor adds a new content blob, adds a new metadata blob, opens an existing content or metadata blob for editing, adds or opens for editing a portion of a link, and so on. Often selection location will not unambiguously identify one of these actions; in such cases, a TDO editor will show a user a list of possible actions and prompt him to select from this list.

Whenever such an unambiguous selection is made, a TDO editor will act as already described above in the description of the preferred embodiment.

### A Second Alternative Embodiment

In a second alternative embodiment, a user is shown screen images similar to ones of the FIG. 5 and FIG. 3 depictions, perhaps embellished with arrows indicating links in the style shown in FIG. 2. The rest of a description of this alternative is closely similar to that of the First Alternative Embodiment and need therefore not be described here.

### Other Alternative Embodiments

There might be other TDO graphical depictions than those described. Such might be used similarly to the descriptions above.

### Conclusion, Ramifications, and Scope of Invention

The problem of digital preservation is urgent; can be addressed only by a distributed, decentralized, and networked infrastructure; and collaboration among all stakeholders to share the responsibility for the fate of digital culture.

As illustrated by this quotation from the Plan for the National Digital Information Infrastructure and Preservation Program, many authors have expressed urgency for preserving authentic digital works. The needs they express exist also for businesses wanting safeguards against fraud, attorneys arguing cases based on the probative value of digital documents, our own personal medical records, and for many individuals, business enterprises, and government agencies. What has been missing are practical tools for inexpensively achieving what the Library of Congress called for in 2002.

We claim that information packaging in Trustworthy Digital Objects is the best known way of applying computing machinery to that part of these needs that can be achieved mechanically. An essential part of such methodology is means for preparing such information packages and for extracting such packaged information for its intended uses. The current invention describes an efficient way of accomplishing this.

TDO packaging can be used for every known kind of information object. TDO packages can be stored in every known kind of digital repository. If the TDO design were to become the core of an international standard, TDOs would be sharable among all institutions and individuals who wanted to preserve useful information for decades or longer.

Curiously, apart from ideas published by the current author [Gladney 2007], these powerful ideas have not been pursued. Nor, before the current invention disclosure, has anybody described how to prepare durably reliable information packages!

What is claimed, a design for computing software called a TDO editor in this disclosure, is:

1. A method of creating and enhancing a data object for preservation, called a TDO, with managing said data object consisting of
(a) fetching zero or more payload pieces that represent information to be preserved, each optionally accompanied by a descriptive piece,
(b) creating an overall descriptive data piece collecting metadata,
(c) generating one or more globally unique identifiers, and
(d) sealing this collected information with cryptographic information so that the resultant package becomes reliable evidence of its own history and provenance.

2. The method recited in claim 1, which further includes means for recording relationships among said information pieces with links, by helping a user specify that each link consists of two or more elements:
(e) whose first element is a bookmark or, alternatively an address, within a payload piece alluded to in claim 1, and where such a bookmark is the kind of bookmark entity used in popular word processing software or an address, optionally represented by a byte offset from the beginning of a data piece within the TDO being created or within some external object;
(f) whose second element is another bookmark or address similar to the first element;
(g) whose third element is optional and is a descriptor of the link being recorded;
(h) with these first and second elements being embedded within TDO content objects 103, 104, 108, 106, or 107, or alternatively being recorded in a relationship block 112 in FIG. 3 together with the third element just alluded to;
(i) with, optionally, either the first or second element further including a globally unique identifier of some object other than the data object being packaged for preservation; and
(j) with any number of further descriptive elements.

3. The method recited in claim 1, whereby said TDO editor prompts a user to select or create a file directory by using a file system management interface provided by a computer's operating system and this TDO editor creates an ephemeral storage representation of an eventual TDO such that, for each file identified in the focal directory, a representation of this content blob or metadata blob is made part of said ephemeral storage representation.

4. The method recited in claim 1, augmented by TDO editor functionality that, whenever an object is added to or deleted from a focal directory, this change induces corresponding changes to an ephemeral storage representation of an eventual TDO.

5. The method cited in claim 1, such that, whenever an entity added to a focal directory or to any subdirectory of this focal directory corresponds to another directory, said TDO editor causes an ephemeral storage representation to be augmented by a further ephemeral storage representation of an eventual TDO, so that TDOs can be recursively nested.

6. The method recited in claim 1 augmented by TDO editor functionality in which, whenever a user requests a check for completeness of the information being prepared, said TDO editor affords the user an opportunity to add a metadata object for each content object not already linked to by such a metadata object and executes such changes.

7. The method recited in claim 1, augmented by TDO editor functionality in which, whenever a user indicates a wish to inspect or edit a selected content data object, or a metadata object, or a link (103, 106, 107, 108, or 111 in FIG. 2), said TDO editor program invokes another editor suitable for said selected content object for inspection and optional change of thereof, and also, whenever the user calls for saving a content piece being so edited, in addition to the usual action of updating its persistent storage copy, the TDO editor also updates its ephemeral storage representation.

8. The method recited in claim 1, in which, whenever a user indicates that a draft TDO being worked on should be saved, a TDO editor creates a persistent storage version of this TDO's ephemeral storage version, prompting the user for any missing content or discrepancy relative to the TDO definition and then augments the draft TDO by invoking cryptographic tools to create a Message Authentication Signature Block (102 in FIG. 2), or said TDO editor affords the user the choice of saving a persistent instance of an imperfect TDO.

9. The method recited in claim 1, in which said TDO editor creates a graphic image that is displayed on a computer screen, or on an alternative display device, further including a cursor mechanism with which the user can select a portion of this image for viewing and editing, with said image depicted in the style of FIG. 2 or FIG. 5 above, or in any other graphical style that shows the parts of a complex object.

10. The method recited in claim 9, in which a keyboard or mouse interaction causes a descriptor of a content object, a metadata object, or a link associated with a selected graphic image portion to be displayed for editing, with editing changes affecting an underlying ephemeral storage representation of said data object in conformance with rules associated with the data type of the selected component.

11. The method recited in claim 9 wherein, if a user selects a screen location between those for two depicted components, said TDO editor affords this human user opportunity to cause a further content objects to be inserted into a draft TDO by identifying one or more files from accessible computing storage, with said TDO editor thereafter making all needed adjustments to a draft TDO representation's names, locations, and addresses so that a refined draft TDO conforms to rules for internal TDO consistency.

12. The method recited in claim 9, wherein the TDO editor affords a user opportunity of selecting two locations within a draft TDO, or one location within this TDO and one object or location outside this draft TDO, whereupon said TDO editor constructs link data within the draft TDO's ephemeral storage representation, thereby effecting a new link as required for a correct TDO.

13. The method recited in claim 1, for a case in which a TDO editor is invoked to update a TDO that was previously completed as recited in claim 8, whereby the TDO editor creates a new TDO that nests the earlier TDO and, whenever any content element of this nested TDO is opened for editing provides the service described in claim 7, except that said TDO editor mirrors each edited and changed TDO component with a new component created in the outer draft TDO and, by adding one or more links, relates this new TDO component to corresponding components within a said nested TDO, and offers a user opportunity to augment metadata associated with this outer TDO element with descriptors of its relationship to the nested TDO element from which it was created.

14. A system for creating and enhancing a data object for preservation, called a TDO, that manages said data object with steps including:
(k) fetching zero or more payload pieces that represent information to be preserved, each optionally accompanied by a descriptive piece,
(l) creating an overall descriptive data piece collecting metadata,
(m) generating one or more globally unique identifiers, and
(n) sealing this collected information with cryptographic information so that the resultant package becomes reliable evidence of its own history and provenance.

15. The system described in claim 14, which further includes means for recording relationships among said information pieces with links, by helping a user specify that each link consists of two or three elements:
(o) whose first element is a bookmark or, alternatively an address within a payload piece, and where such a bookmark is the kind of bookmark entity used in popular word processing software or an address represented in a well-known way, such as a byte offset from the beginning of a data piece to which it belongs;
(p) whose second element is another bookmark or address similar to the first element;
(q) whose third element is optional and is a descriptor of the link being recorded;
(r) with these first and second elements being embedded within TDO content objects 103, 104, 108, 106, or 107, or alternatively being recorded in a relationship block 112 in FIG. 3 together with the third element just alluded to; and
(s) with, optionally, either the first or second element further including a globally unique identifier of some object other than the data object being packaged for preservation; and
(t) with any number of further descriptive elements.

16. The system described in claim 14, whereby said TDO editor prompts a user to select or create a file directory by using a file system management interface provided by a computer's operating system and, this TDO editor creates an ephemeral storage representation of an eventual TDO such that, for each file identified in the focal directory, a representation of this content blob or metadata blob is made part of said ephemeral storage representation.

17. The system described in claim 14, augmented by TDO editor functionality that, whenever an object is added to or deleted from a focal directory, this change induces corresponding changes to an ephemeral storage representation of an eventual TDO.

18. The system described in claim 14 augmented by TDO editor functionality in which, whenever a user requests a check for completeness of the information being prepared, said TDO editor affords the user an opportunity to add a metadata object 106 for each content object 107 not already linked to by such a metadata object and executes such changes.

19. The system described in claim 14, augmented by TDO editor functionality in which, whenever a user indicates a wish to inspect or edit a selected content data object, or a metadata object, or a link (103, 106, 107, 108, or 111 in FIG. 2), said TDO editor program invokes another editor suitable for said selected content object for inspection and optional change of said selected content object, and also, whenever the user calls for content being so edited to be saved, in addition to the usual action of updating its persistent storage copy, the TDO editor also updates its ephemeral storage representation.

20. The system described in claim 14, in which, whenever a user indicates that a draft TDO being worked on should be saved, a TDO editor creates a persistent storage version of this TDO's ephemeral storage version, prompting the user for any missing content or discrepancy relative to the TDO definition and then augments the draft TDO by invoking cryptographic tools to create a Message Authentication Signature Block (102 in FIG. 2), or said TDO editor affords him the choice of saving a persistent instance of an imperfect TDO.
